(19) United States
(12) Patent Application Publication
(10) Pub. No.: US 2004/0126669 A1
(43) Pub. Date: Jul. 1, 2004

(54) Method for producing holographic iridescent film

(76) Inventor: Henry W. Ruschmann, Bernardsville, NJ (US)

Correspondence Address: Kenneth Watov, Esq., P.O. Box 247, Princeton Junction, NJ, 08550, US

(21) Appl. No.: 10/629,457

(22) Filed: Jul. 29, 2003

Related U.S. Application Data
(60) Provisional application No. 60/404,098, filed on Aug. 15, 2002.

(51) Int. Cl. G03H 1/04; B32B 5/02

(52) U.S. Cl. 430/1; 430/2; 264/1.31; 442/162

(57) ABSTRACT

A method of producing holographic iridescent film includes the steps of applying an adhesion coating upon a corona or plasma treated iridescent film, holographically embossing the adhesion coating, thermosetting the holographically embossed adhesion coating, and applying a high-resolution index (HRI) coating to the thermo-set holographically embossed adhesion coating.

### RELATED APPLICATION

The present Application claims priority from U.S. Provisional Application Serial No. 60/404,098, filed on Aug. 15, 2002.

### FIELD OF THE INVENTION

The present invention is related generally to iridescent films, and particularly to holographic embossing of such films.

### BACKGROUND OF THE INVENTION

There is a need in the art for methods to produce thin gauge holographic iridescent film with a high refractive optical index. The film should be capable of producing both iridescent colors and holographic/prismatic information that is visible under various types of light. The development of such prismatic effects generated by holographic methods will enable information in the film to be used for both decorative and document/product authenticity. Similar effects can be achieved when applying the film in cut up, particle form.

### SUMMARY OF THE INVENTION

The present invention is directed to a method for producing iridescent holographic optically enhanced decorative and or security film. A multi-layered iridescent film is print treated to accept a thermo-set embossing resin. The resin coating is holography embossed and then thermo-set (hardened). The film is then treated with a high refractive optical enhancement.

The process is economically advantageous in that it produces the advantage effects of four different films into one in-line processed film. The film is also colorfast/fade resistant, solvent resistant, water based and non-metallic. The film is easy to cut, laminate, combine with resins, print, vacuum treat or otherwise convert. Because one film can replace a variety of heavier and more costly film combinations, it is ideally suited for a variety of applications.

### BRIEF DESCRIPTION OF THE DRAWING

FIG. 1 is a block schematic illustration of an apparatus used to produce holographic iridescent film according to one embodiment of the present invention.

### DETAILED DESCRIPTION OF PREFERRED EMBODIMENTS

According to the present invention, Iridescent Holographic Film is produced by a process comprising coating a poly-plastic multi-layered iridescent web with a holographic embossing, which can later be further optically enhanced.

Specific embodiments of the present invention will now be described in detail. These embodiments are intended to be illustrative only, and the invention is not limited to the materials, conditions or process parameters set forth in these embodiments.

According to the present invention the multi-layered poly-plastic web or iridescent film includes, but is not limited to corona or plasma treated polyester, polypropylene, acrylic, polyvinyl chloride (PVC), or cellulose acetate. Required untreated base film is available from Englehard Industries Inc. (series 8861, 8601, 8181, 8511, 4221, 3181). In various embodiments, the web or film has a thickness of about 0.00045 inch to about 0.020 inch thick. Preferably the web is about 0.0012 inch thick. Some multi-layered iridescent films are available from Taiwan, and 3M.

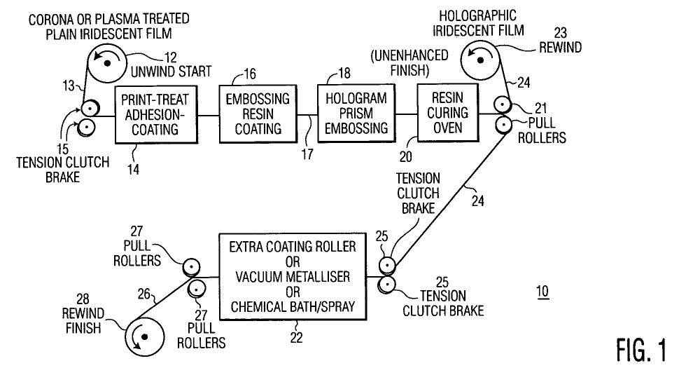

In various embodiments, the size and shape of the iridescent web or film can be any suitable size roll as desired for the particular processing equipment. However, a roll of such film material about 40 inches wide and several thousand feet in length permits the material to be continuously drawn through the in-line production equipment 10 (see FIG. 1) described below by a pair of rollers 15 with tension clutch brake located downstream of the bulk roll 12 of iridescent film 13. It is believed that one of ordinary skill in the art will be able to alter the size and variety of the iridescent film in view of the present disclosure to suit particular uses or process conditions. An adhesion coating 14 is applied to the iridescent web 13.

The adhesion coating/treatment 14 allows the subsequent embossing thermo-set resin coating 16 to be applied evenly. In one embodiment, the thickness of the adhesion coating 14 is about 0.00005 inch. In various embodiments, this treatment can be applied as a solvent (ethyl alcohol), or resin (PVC/styrene reduced to 10% resin) resin, with a flexographic or gravure roller. A plasma treatment in a vacuum system or a water based and UV cured print treatment system can also be used. The plasma treatment is the preferred embodiment.

The adhesion coating 14 is then coated with a resin embossing coating 16. The resin embossing coating 16 can be either thermo-set or thermoplastic. Thermo-set gives added solvent resistance and heat stability. Thermo-set systems include but are not limited to vinyl resins and epoxy resins which are cross-linked by heat. Thermoplastic urethane and water-based resins or combinations thereof are cured by ultraviolet (UV) light and lower temperature.

Optical clarity of the resin will affect the viewable color spectrum and holographic information intensity. In various embodiments, a pigment or plurality of chemicals or elements can be mixed with a clear, cured or semi-cured resin. The pigment may be present in the resin in any effective amount. The resin thermo-set embossing coating 16 is applied with a flexographic or gravure roller, to fill in the spectrum stretches in the iridescent film 13. An optically flat surface is necessary for embossed holograph.

Next, the uncured or semi-cured resin and adhesion coated iridescent web 17 is passed through a set of holographic embossing roller(s) 18. In various embodiments, the iridescent film 13 can be coated on one or both sides simultaneously or after curing one side of the film 13.

Next, the thermo-set resin is cured (baked, dried, cross-linked) in an oven 20 to achieve maximum solvent resistance. Curing time in the oven varies with the type and thickness, ex. (0.0005 to 0.0015 inch thick) of the selected resin, ex. (150-350 deg. F.), for ex. (5 to 25 seconds). Thermoplastic and water based systems are cured in accordance with the manufacturer's protocol. The unenhanced processed film 24 can in one embodiment be fed via pull rollers 21 to a takeup roll 23.

In other embodiments, after curing the resin, a metallic or non-metallic high-resolution index coating 22 can be applied via pull rollers 21 to rollers 25 with a tension clutch brake, and therefrom to the holographic surface side of the film to further enhance the overall spectral effect. This enhancement, high-resolution index (HRI), can be applied to the film 24 either by vacuum deposition (aluminum, gold, silver, bismuth, etc.), or by using a bath of (silver halide, nickle), or by solution coating as demonstrated above with the adhesion coating 14. In this example the enhanced film 26 is fed via pull rollers 27 to a takeup roll 28.

The finished film 24, 26 can now be converted by slitting, sheeting, laminating, die cutting, folding, shaping or molding, printing or further color coating, or spraying as cut up particles.

What is claimed is:

1. A method of producing holographic iridescent film comprising the steps of:
applying an adhesion coating upon a corona or plasma treated iridescent film; and
holographically embossing said adhesion coating.

2. The method of claim 1, further including the steps of thermosetting said holographically embossed adhesion coating.

3. The method of claim 2, further including the step of applying a high-resolution index (HRI) coating to the thermo-set holographically embossed adhesion coating.

4. The method of claim 1, where in the applying step is carried out by plasma treatment in a vacuum.

5. The method of claim 1, wherein the applying step is carried out by a water based and UV cured print treatment.
